(19) United States
(12) Patent Application Publication
(10) Pub. No.: US 2014/0344675 A1
(43) Pub. Date: Nov. 20, 2014

(54) METHOD AND SYSTEM FOR BROWSING BOOK DATA ON COMPUTER TERMINAL

(71) Applicant: Hsien-Wen Chang, New Taipei City (TW)

(72) Inventor: HSIEN-WEN CHANG, New Taipei City (TW)

(21) Appl. No.: 14/084,621

(22) Filed: Nov. 20, 2013

(30) Foreign Application Priority Data
May 16, 2013 (TW) 102117383

(51) Int. Cl. G06F 17/21; G06F 3/0483

(52) U.S. Cl. CPC G06F 17/211; G06F 3/0483
USPC 715/244; 715/243

(57) ABSTRACT

A method and system for browsing book data on a computer terminal are provided. The method includes: providing a book database including a plurality of book data, each book data including a book cover image, a book spine image, and a bibliographic data associated with a book; a servo computer providing, in response to a query sent from a user by the computer terminal, a book data webpage or application-related book data interface to be displayed on a display of the computer terminal of the user, wherein the book data interface includes an archival zone having at least a virtual bookshelf space; and displaying the book spine images of the book data fetched from the servo computer in the virtual bookshelf space side by side so as to display more said book data in the archival zone, thereby enabling intuitive, user-friendly, and convenient browsing book data.

### BACKGROUND OF THE INVENTION

1. Field of the Invention

The present invention relates to methods and systems for browsing book data, and more particularly, to a method and system for displaying a plurality of book data in optimal layout on a display interface such that users can browse the book data on a computer terminal quickly.

2. Description of the Prior Art

Due to advancement of network technology and rapid development of e-commerce, online bookstores substitute partially for conventional physical bookstores in which physical books are displayed and browsed by consumers who then determine whether to buy the physical books. It is because the consumers can access online bookstores which are always available around-the-clock anywhere, including home and workplace, with a view to browsing and purchasing books. Furthermore, online bookstores have strong pricing competitive advantage, because they pay no rents, incur low inventory costs, and hire few employees. Moreover, unlike conventional physical bookstores whose book selections are limited to bookstore area and inventory, online bookstores offer the consumers much more diverse selections. Last but not least, the success of Amazon Online Bookstore (Amazon.com) turns a new page in global bookstores, as plenty of conventional physical bookstores cannot but start operating an affiliated online bookstore for averting customer loss.

Online bookstores are usually operated by means of either a Web-based webpage interface or an APP application interface.

As regards the Web-based webpage interface, the most typical online bookstore interface requires a user to enter a URL or IP address with a computer terminal and then get connected to the website of the online bookstore. Afterward, the frame displayed on the user's computer terminal is substantially shown in FIG. 1. The webpage interface 1 comprises a first menu 10 on the left and a second menu 11 above, wherein a book data display region 12 is centrally located and is relatively large. The first menu 10 usually enumerates the categories of books (such as law, finance, and literature.) The second menu 11 usually enumerates theme commodities, discount-related messages, or function/operation-related messages. In the book data display region 12, book cover images 130 of books 13 in stock are displayed in thumbnail format and spaced apart from each other transversely and vertically. The lower portion of the book cover image 130 bears the ask price of the book 13 or a short text message 131. To access the contents of the book 13, the consumers click on the book cover image 130 to open the webpage which presents the bibliographic data of the book 13 in detail or presents an introduction to the book 13.

As regards the APP application interface, the most typical book application requires the user to download, install, and start the book application such that an application interface 2 shown in FIG. 2 displays a virtual bookshelf 20. The virtual bookshelf 20 looks like a simulated physical bookshelf and comprises multiple rows of virtual book-holding spaces 200 which lie transversely. After the users have purchased electronic books 21 from an online bookstore or downloaded the electronic books 21 from an APP market, book cover images 210 of the electronic books 21 are displayed, in thumbnail format and spaced apart from each other, in the virtual book-holding spaces 200. The user clicks on the book cover images 210 to browse bibliographic data or open the electronic books 21, respectively.

Whichever foresaid interface display modes are in use, the book cover images of the books are always displayed in thumbnail format and spaced apart from each other to enable a user to browse the book cover images and find an intended book quickly, because the book cover of a book is usually best designed, representative of the contents, or topic-related concepts of the book. However, although the book cover is displayed in thumbnail format, the thumbnail is of a considerable width and height. Also, to enable the users to distinguish the books, the book cover images of the books are always spaced apart from each other. As a result, only a few thumbnails of book cover images of a limited numbers of books are displayed on a single computer screen, especially fewer on the screen of tablet computers and smart phones because they have a smaller screen. Although users can find more book cover images in thumbnail format with a vertical or horizontal scroll bar or can slide-to-view more books on a touch screen with a finger, it is inconvenient for the users to do so for reasons as follows: it requires additional operation; it is time-consuming; and, in case of an overdone slide, it will be difficult for users to locate again a book which the users encounter previously and are interested in.

### SUMMARY OF THE INVENTION

In view of this, the present invention provides a method and system for browsing book data on a computer terminal to display more book data on the computer terminal with a screen of a limited size and thereby enable users to browse the book data quickly and easily.

One aspect of the present invention is directed to a method for browsing book data on a computer terminal, the method comprising the steps of: providing an online book database, the book database comprising a plurality of book data, each book data being attributed to a physical or electronic book, the each book data at least comprising a book cover image, a book spine image, and a bibliographic data associated with the book; providing, in response to a query sent from a user by the computer terminal, a book data interface to be displayed on a display of the computer terminal; displaying an archival zone on the book data interface, the archival zone comprising at least a virtual bookshelf space; and displaying the book spine images of the book data in the virtual bookshelf space side by side so as to display more said book data in the archival zone.

Another aspect of the present invention is directed to a method for browsing book data on a computer terminal, the method comprising the steps of: providing a book data application installed and executed on the computer terminal to display a book data interface on a display, the book data interface comprising an archival zone having at least a virtual bookshelf space; providing a book database, the book database comprising a plurality of book data, each book data being attributed to a physical or electronic book, the each book data at least comprising a book cover image, a book spine image, and a bibliographic data associated with the book; and fetching at least a book data from the book database in response to a query sent from a user by the computer terminal, sending the book data to the computer terminal, and displaying book spine images of the book data in the virtual bookshelf space side by side so as to display more said book data in the archival zone.

Yet another aspect of the present invention is directed to a system for browsing book data on a computer terminal, the system comprising: a processor; a storage device; a book data interface provided and displayed on a display on the computer terminal in response to a query sent from a user by the computer terminal, the book data interface comprising an archival zone having at least a virtual bookshelf space; and a book database stored in the storage device and accessible by the computer terminal, the book database comprising a plurality of book data, each said book data being attributed to a physical or electronic book, each said book data at least comprising a book cover image, a book spine image, and a bibliographic data associated with the book; wherein, after fetching the book data, the computer terminal displays the book spine images of the book data in the virtual bookshelf space side by side so as to display more said book data in the archival zone.

### BRIEF DESCRIPTION OF THE DRAWINGS

FIG. 1 (PRIOR ART) shows a conventional webpage interface for displaying book data;

FIG. 2 (PRIOR ART) shows a conventional application interface for displaying book data;

FIG. 3 is a schematic view of the system according to the first embodiment of the present invention;

FIG. 3A is a schematic view of contents of book data according to the first embodiment of the present invention;

FIG. 4 is a schematic view of the method for browsing book data according to the first embodiment of the present invention;

FIG. 5 is a schematic view of relationship between a book spine image and a book cover image according to the first embodiment of the present invention;

FIGS. 6A-6D shows exemplary frames of operation of a book data webpage according to the first embodiment of the present invention;

FIG. 7 is a flow chart of operation of the book data webpage according to the first embodiment of the present invention;

FIG. 8 is a schematic view of the system according to the second embodiment of the present invention;

FIG. 9 is a flow chart of the method for browsing book data according to the second embodiment of the present invention; and

FIG. 10 is an exemplary frame of operation of a book data interface according to the second embodiment of the present invention.

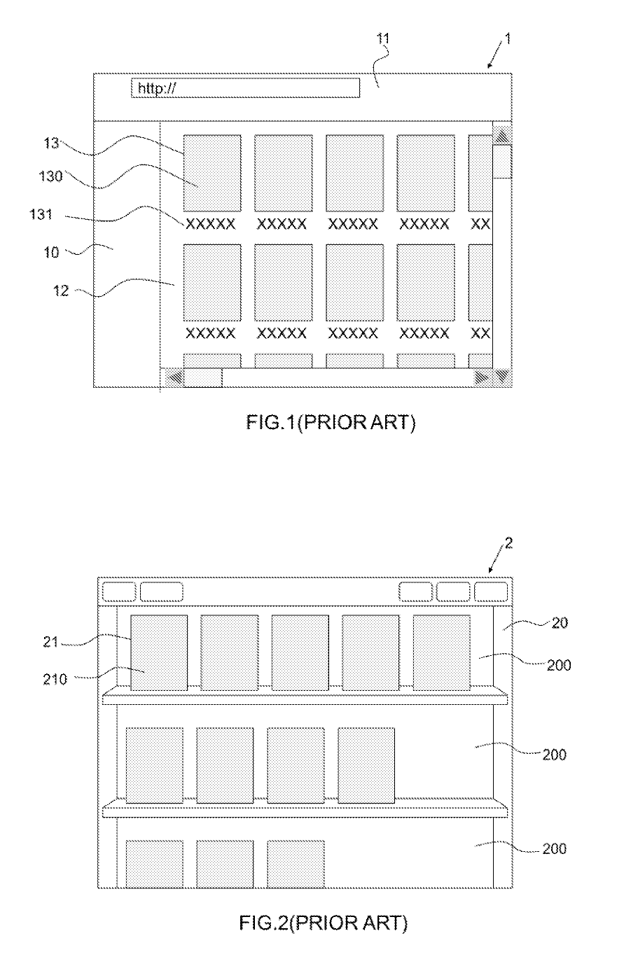

### DETAILED DESCRIPTION OF THE EMBODIMENTS

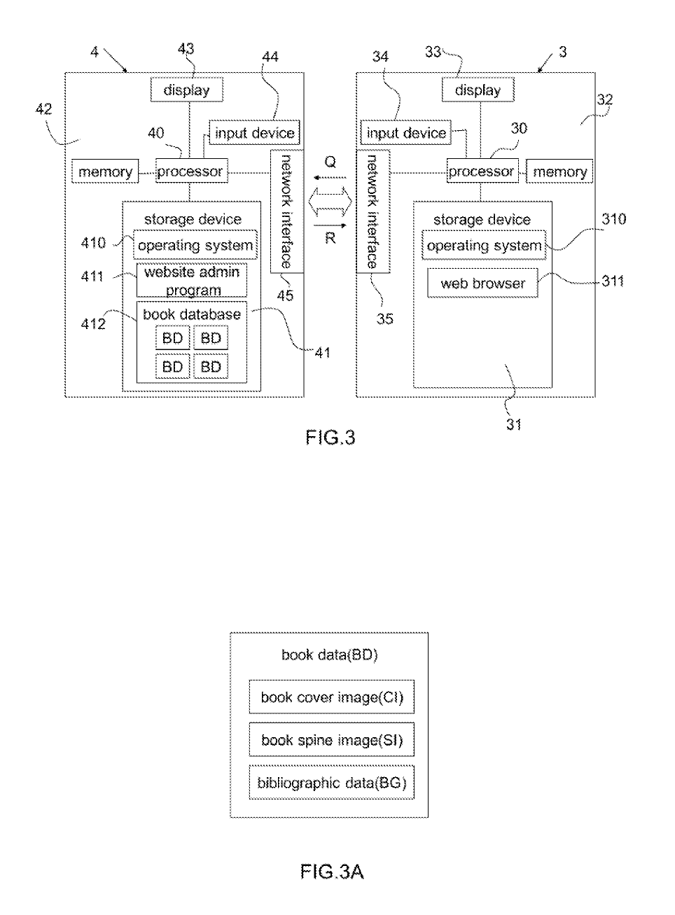

Referring to FIG. 3, there is shown a schematic view of the system for browsing book data on a computer terminal according to the first embodiment of the present invention. The system is a network framework which comprises at least a servo computer 4 and at least a computer terminal 3. The computer terminal 3 can be a notebook computer, a desktop computer, a tablet computer, or a smart phone, which has therein various computing or data processing devices electrically coupled to each other, including a processor 30, a storage device 31, a memory 32, a display 33, an input device 34, and a network interface 35, for inputting, processing, and outputting data. The input device 34 can be a mouse, a keyboard, a touch pad, a touch panel, or a voice recognition apparatus. The storage device 31 is installed thereon with an operating system 310 and a web browser 311. Likewise, the servo computer 4 comprises a processor 40, a storage device 41, a memory 42, a display 43, an input device 44, and a network interface 45 which are electrically coupled to each other. The input device 44 can also be a mouse, a keyboard, a touch pad, a touch panel, or a voice recognition apparatus. The storage device 41 is installed thereon with an operating system 410, a website administration program 411, and a book database 412. The book database 412 comprises a plurality of book data BD. Each book data BD is attributed to a physical or electronic book and specifically comprises a book cover image CI, a book spine image SI, and a bibliographic data BG associated with the book, as shown in FIG. 3A. In this regard, the book data BD of the present invention are not restricted to books literally, but also include magazines, manuals, handouts, and even music CD, software CD, data CD, audiovisual DVD/VCD, and the like. That is to say, the claims of the present invention apply to any sharable, tradable, and physical articles which carry abstract information and bear the aforesaid book cover image, book spine image and bibliographic data.

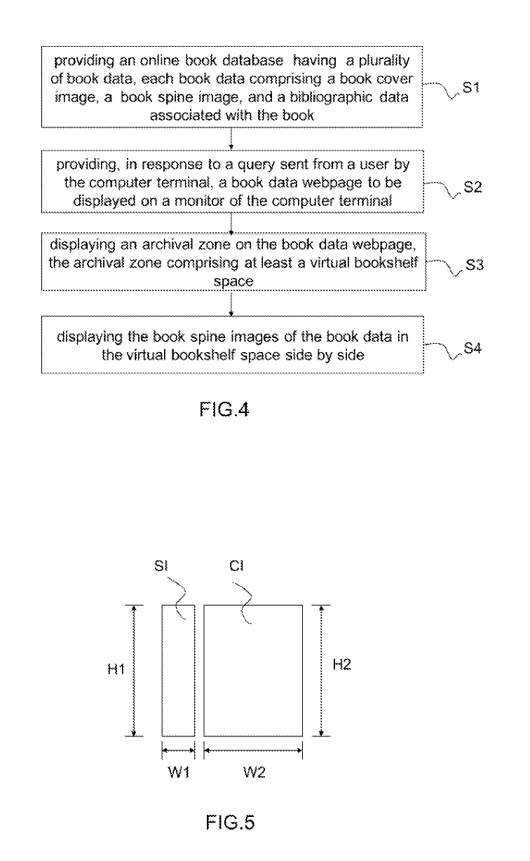

Referring to FIG. 4 (and making reference to FIG. 3 and FIG. 5 as needed), the present invention provides a method whereby a user browses book data on a computer terminal according to the first embodiment.

In step S1, an online book database 412 is provided in the storage device 41 of the servo computer 4. As mentioned above, the book database 412 comprises a plurality of book data BD. Each book data BD is attributed to a physical or electronic book and specifically comprises a book cover image CI, a book spine image SI, and a bibliographic data BG associated with the book. Referring to FIG. 5, each book spine image SI is substantially rectangular and has a first width W1 and a first height H1, whereas the book cover image CI corresponding in position to the book spine image SI is also substantially rectangular and has a second width W2 and a second height H2. The dimensions of the book spine image SI and book cover image CI are reduced in proportion to the dimensions of the book spine and book cover of the corresponding physical book, respectively, such that the H1 heights of the book spine images SI reflect the heights of the corresponding physical books, respectively.

In step S2, a user sends a query Q to the servo computer 4 by means of a computer terminal 3, for example, by entering a URL indicative of the servo computer 4 into a URL bar of a web browser or by clicking on a hyperlink in a document or webpage. The query Q is about the user's requesting the servo computer 4 to provide an interface for a book data webpage 5 such that the interface can be displayed on the display 33 on the computer terminal 3 of the user. If the servo computer 4 accepts the query Q, the servo computer 4 will send contents R to the computer terminal 3, such that the contents R will be displayed on the book data webpage 5 by a web browser 311 of the computer terminal 3.

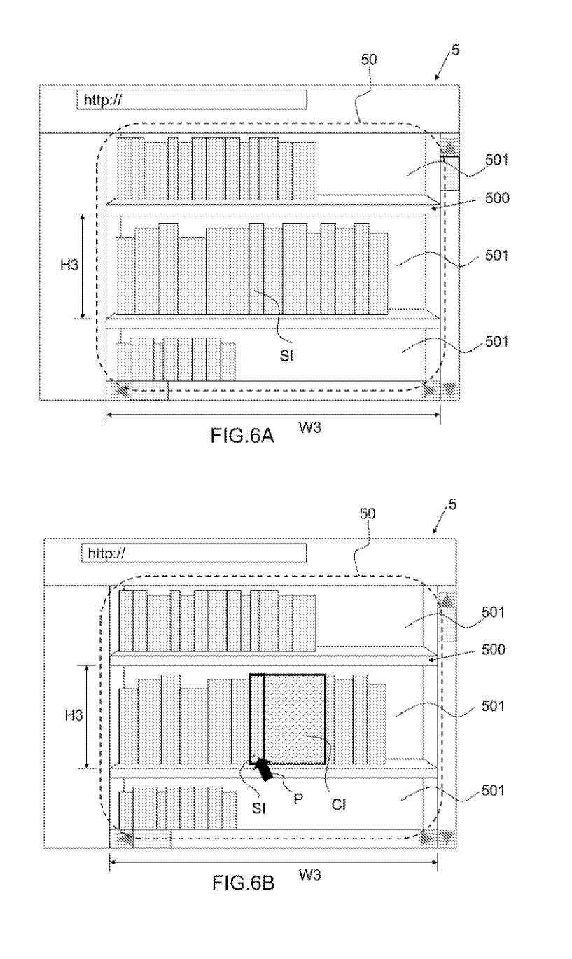

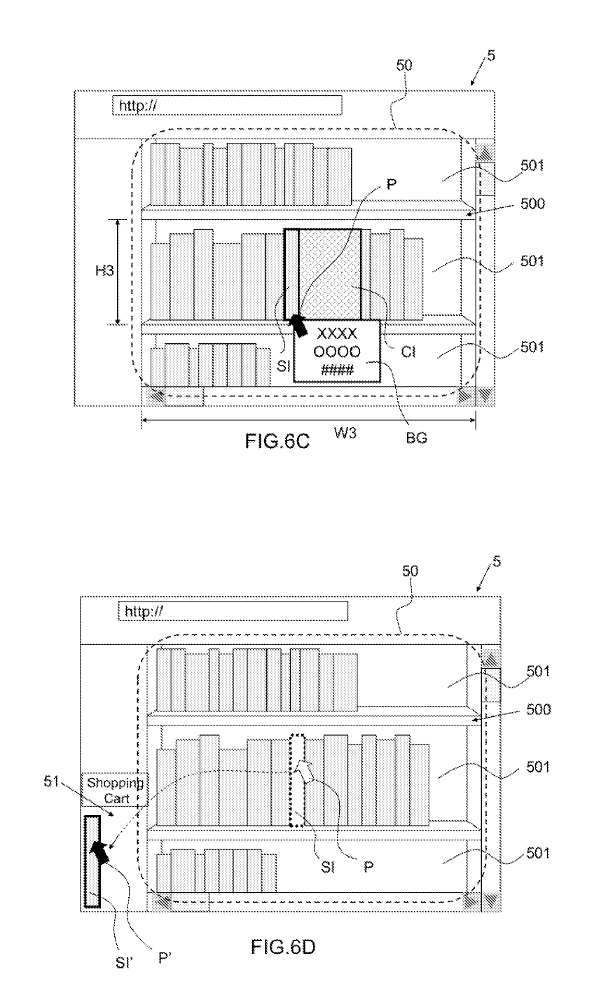

Referring to FIG. 6A, in step S3, an archival zone 50 is displayed on the book data webpage 5 and comprises at least a virtual bookshelf space 500. Each virtual bookshelf space 500 comprises at least a virtual storage unit 501. Each virtual storage unit 501 has a third width W3 and a third height H3. In an embodiment of the present invention, the at least a virtual bookshelf space 500 is simulated to assume the appearance of a physical bookshelf, but the present invention is not limited thereto. The aforesaid objectives and advantages of the present invention can be attained, provided that multiple layers or multiple rows of spaced-apart receiving spaces are provided, and each layer or row of spaced-apart receiving spaces contains therein book spine images SI arranged side by side and regularly.

In step S4, all the book spine images SI of the plurality of book data BD are arranged in the virtual storage unit 501 of the virtual bookshelf space 500 side by side. The first width W1 of the book spine images SI is much less than the second width W2 of the book cover image CI, and adjacent said book spine images SI are either not spaced apart by any distance or spaced apart by a small distance; hence, a single virtual storage unit 501 is capable of receiving a large number of said book spine images SI, wherein each book spine image SI represents a physical or electronic book. Accordingly, on the whole, the virtual bookshelf space 500 in its entirety can display more book data than its conventional counterparts can.

Preferably, all the book spine images SI are received in the virtual storage unit 501 in upright manner, though the book spine images SI, in part or in whole, can be received in the virtual storage unit 501 in prone manner as needed.

Furthermore, to enhance the space utilization of the book spine images SI received in the virtual storage unit 501, the third width W3 of the virtual storage unit 501 is not less than the first width W1 of the book spine images SI (wherein W3 is preferably much larger than W1), and the third width W3 is a predetermined fixed width. If a total of the first widths W1 of all the book spine images SI arranged in one of the at least a virtual storage unit 501 in a predetermined sequence (for example, arranged according to the number of strokes of the Chinese characters of the book titles) exceeds the third width W3 of the virtual storage unit 501, at least a final book spine image SI will be moved automatically to another adjacent (for example, the next layer of) said virtual storage unit 501 and arranged therein, such that the total of the first widths W1 of all the book spine images SI in the virtual storage unit 501 does not exceed the third width W3 of the virtual storage unit 501.

The third height H3 of the virtual storage unit 501 is not less than the first height H1 of the book spine image SI and is a predetermined height. If the virtual storage unit 501 has therein the book spine images SI and the first height H1 of at least one of the book spine images SI exceeds the predetermined height, the third height H3 will increase automatically to equal or exceed the maximum first height H1. Alternatively, it is feasible that the virtual storage units 501 have at least two different heights H3, respectively, and the virtual storage unit 501 with one of the two different heights H3 contains only the book spine images SI of the height H1 which is not larger than the height H3 of the virtual storage unit 501. For example, as shown in FIG. 6A, the height of the second virtual storage unit 501 is larger than the height of the first virtual storage unit. Hence, with the aforesaid automatic height adjustment technique, the heights of different said book spine images SI correlate with the heights of the corresponding physical books, respectively, to enable the user to estimate the dimensions of the physical book. By contrast, the prior art discloses all book cover images being displayed in form of thumbnails of the same size, thereby lacking ease of use—users are unaware of the dimensions of the physical books indicated by the thumbnails, respectively.

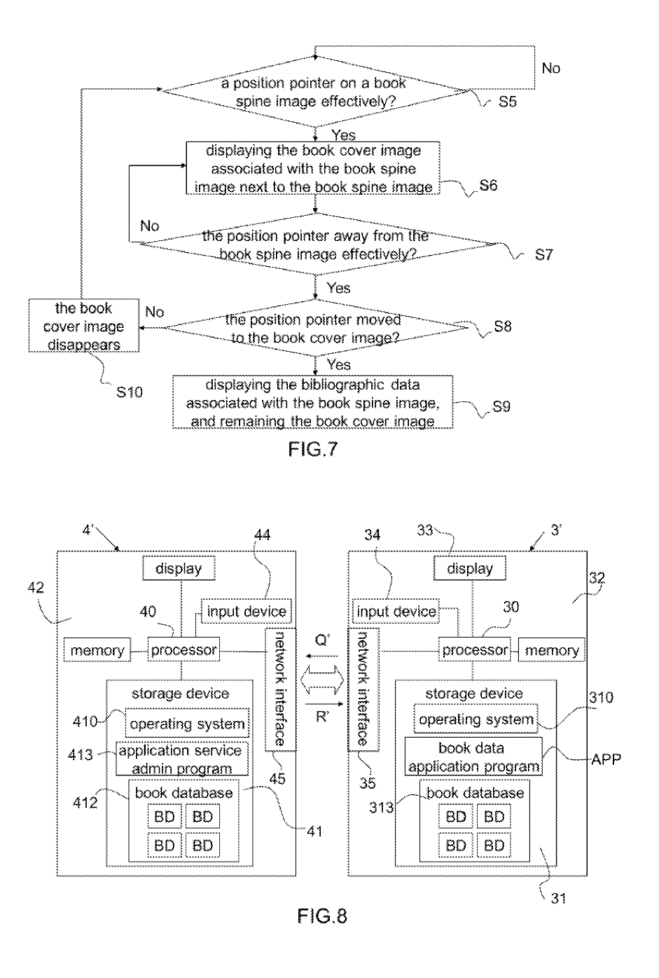

Referring to the flow chart of FIG. 7 (and making reference to FIGS. 6A, 6B, 6C, 6D as needed,) step S5 entails determining whether the user has moved a position pointer P (such as a cursor or a touch point) on the computer terminal to any book spine image SI effectively (for example, on or close to the book spine image SI) in the virtual bookshelf 500. If the determination is affirmative, the process flow will go to step S6. Referring to FIG. 6B, in step S6, the book spine image SI undergoes an eye-catching change (for example, enlarging, taking on a bold external border, shaking, flashing, or undergoing any change that draws a user's attention.) or tactile change. Preferably, the book cover image CI associated with the book spine image SI is not only showed next to one side of the book spine image SI, that is, either the right side of the book spine image SI or the left side of the book spine image SI (FIG. 6B is exemplified by the right side), but also automatically adjusts the dimension thereof proportionately such that the second height H2 of the book cover image CI equals the first height H1 of the book spine image SI to present the book spine image SI and the book cover image CI together in a way of simulating an opened book. However, the above features are not restrictive of the present invention, as the book cover image CI can also be displayed at any other appropriate position on the book data webpage 5.

Step S7 entails determining whether the position pointer P has been effectively moved away from the book spine image SI. If it is determined that the position pointer P has not yet been effectively moved away from the book spine image SI, the process flow will go back to step S6 to keep displaying the book cover image CI. If it is determined that the position pointer P has been moved away from the book spine image SI effectively, the process flow will go to step S8. Step S8 entails determining whether the position pointer P has been moved to the book cover image CI effectively. If it is determined that the position pointer P has been moved to the book cover image CI effectively and has stayed therein for at least a predetermined duration or has selected the book cover image CI, step S8 will further involve displaying the book cover image CI continuously, and then the process flow will go to step S9. Step S9 entails displaying the bibliographic data BG associated with the book spine image SI, wherein the bibliographic data BG is displayed below the book cover image CI immediately as shown in FIG. 6C; alternatively, the bibliographic data BG is displayed on the right side of the book cover image CI, at any specified zone (for example, the leftmost functional zone) of the book data webpage 5, or in a new window. If, in step S8, it is determined that the position pointer P has not yet been moved to the book cover image CI effectively, the process flow will go to step S10. In step S10, the book cover image CI disappears and therefore is no longer displayed.

If the user moves a position pointer P to one of the book spine images SI effectively and selects it (for example, moving a mouse cursor to the book spine image SI and then clicking and holding the left button of the mouse; or, when using a touch screen, the user's finger touches the book spine image SI for a period of time which exceeds a predetermined duration,) the selected book spine image can be moved together with the position pointer. In doing so, for example, not only can the user change the sequential position of a specific book spine image SI in the same virtual storage unit 501 or move it to the other virtual storage unit 501, but the servo computer 4 also can record its new position and store data pertaining thereto. Alternatively, the user can move one or more book spine images SI to a specific functional zone of the book data webpage 5 to perform a specific functional operation thereon, thereby treating the specific functional zone as the user's favored archive. Alternatively, as shown in FIG. 6D, the user moves the book spine image from SI to SI′ to put an intended book in a shopping cart 51—an operation whereby the user is prepared to buy or borrow or rent a book. In these cases, the original selected book spine image SI which has been removed elsewhere will become inoperable in a manner of disappearing, being transparent, or being marked otherwise.

Referring to FIG. 8, there is shown a schematic view of the system for browsing book data according to the second embodiment of the present invention. The system described in the second embodiment and illustrated with FIG. 8 is identical mostly to the system described in the first embodiment and illustrated with FIG. 3 and thus like components thereof are denoted with like reference numerals. The system in the second embodiment is different from the system in the first embodiment in that, in the second embodiment, the storage device 41 of a servo computer 4′ has an application service administration program 413, whereas the storage device 31 of a computer terminal 3′ has a book data application program APP and a book database 313.

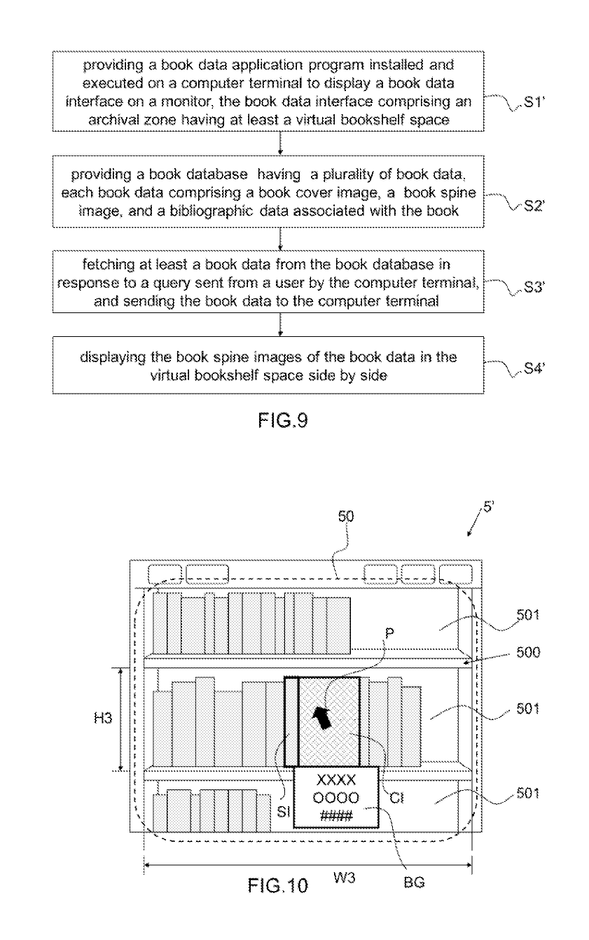

Referring to FIG. 9 and making reference to FIG. 8 and FIG. 10, the method in the second embodiment is identical mostly to the method in the first embodiment in terms of a technical solution and thus like components thereof are denoted with like reference numerals. The difference between the method in the second embodiment and the method in the first embodiment is described below. First, step S1′ entails providing a book data application program APP by the servo computer 4′ with the application service administration program 413, wherein the book data application program APP is installed on the computer terminal 3 and executed thereon to display a book data interface 5′ on the display 33, and the book data interface 5′ comprises an archival zone 50 with at least a virtual bookshelf space 500. In general, the book data application program APP acquired by the computer terminal 3 is either provided by the application service administration program 413 of the servo computer 4′ or downloaded from an open application market. Alternatively, the computer terminal 3′ has therein the built-in book data application program APP.

Step S2′ entails providing an online book database by the servo computer 4′ as step S1 in the first embodiment does, and thus step S2′ is not described herein for the sake of brevity.

In step S3′, the user uses the computer terminal 3 to send a query Q′ to the servo computer 4′, and, in response to the query Q′, the servo computer 4′ fetches at least a book data BD from the book database 412 and sends contents R′ to the computer terminal 3′, such that the book data interface 5′ is displayed by a book data application program APP of the computer terminal 3′, wherein the display manner is described in step S4′, that is, the book spine images SI of the book data BD are arranged in the virtual bookshelf space 500 side by side, such that more said book data are displayed in the archival zone 50. The actual operating environment and method in the second embodiment are the same as that depicted in FIG. 5 through FIG. 7 for the first embodiment. In the second embodiment, the way of displaying book data on the book data interface 5′ displayed by the book data application program APP is usually applicable to the display 33 with the computer terminal 3′ having a touch panel; hence, the position pointer P in the this embodiment refers to the touch gesture of a finger or a touch pen/stylus.

In addition, every single virtual storage units 501 containing a plurality of book spine images can be moved laterally and independently, which facilitate the user to browse more book spine images hidden by the side edge of the virtual bookshelf space 500, provided that the third width W3 is much wider than the width of the archival zone shown on the display. For one example, there may be a scroll bar showed on the bottom side of each virtual storage units 501, if the book data interface is the webpage as aforesaid first embodiment. For another example, each virtual storage units 501 can slide laterally by means of a touch gesture of the user, if the book data interface is the book data application program as aforesaid second embodiment with a touch panel.

Accordingly, given the aforesaid technical features of the present invention, it is feasible to display more book data neatly arranged within a display area on a screen with limited size such that a user can browse the book data easily and quickly and find an intended book without scrolling or sliding a frame overly. The user can display more data, such as book cover or bibliographic data, on the screen laterally by selecting simply a book spine image with a mouse cursor or a touch gesture. The present invention features simulating physical book dimensions with book spine images and provides a virtual bookshelf space which suits flexibly the sum of the height and the width of the book spine images to enable the book data displayed and arranged on the book data interface in its entirety to look real and be intuitive, enhance the space utilization of the frame, enable the user to change the positions of the book spine images freely and thereby facilitates automatic classification or sorting, enable the user to build a private book database or undertake book shopping in a user-friendly and convenient manner. The present invention is applicable to the archiving and lending service offered by a library, online transaction that involves the buying, selling, renting, and/or lending of books, and any field that involves sharing or transacting book-related information.

The present invention is disclosed above by exemplary embodiments. However, persons skilled in the art should understand that the exemplary embodiments are illustrative of the present invention only, but should not be interpreted as restrictive of the scope of the present invention. Hence, changes and modifications made to the aforesaid embodiments without departing from the spirit embodied in the present invention should fall within the scope of the present invention. Accordingly, the legal protection for the present invention should be defined by the appended claims.

What is claimed is:

1. A method for browsing book data on a computer terminal, the method comprising the steps of:
providing an online book database, the book database comprising a plurality of book data, each book data being attributed to a physical or electronic book, the each book data at least comprising a book cover image, a book spine image, and a bibliographic data associated with the book;
providing, in response to a query sent from a user by the computer terminal, a book data interface to be displayed on a display of the computer terminal;
displaying an archival zone on the book data interface, the archival zone comprising at least a virtual bookshelf space; and
displaying the book spine images of the book data in the virtual bookshelf space side by side so as to display more said book data in the archival zone.

2. The method of claim 1, wherein the book spine images attributed to the book data are arranged in the virtual bookshelf space side by side in either upright or prone manner.

3. The method of claim 1, wherein the book spine images are substantially rectangular and have a first width and a first height, and the book cover images are substantially rectangular and have a second width and a second height, wherein the virtual bookshelf space comprises at least a virtual storage unit with a third width and a third height.

4. The method of claim 3, wherein the third width of the at least a virtual storage unit is not less than the first width of the book spine image, the third width being a predetermined fixed width, wherein, if a total of the first widths of all the book spine images arranged in one of the at least a virtual storage unit in a predetermined sequence exceeds the third width of the virtual storage unit, the final book spine image will be moved automatically to another adjacent said virtual storage unit and arranged therein, such that the total of the first widths of all the book spine images in the virtual storage unit does not exceed the third width of the virtual storage unit.

5. The method of claim 3, wherein the third height of the at least a virtual storage unit is not less than the first height of the book spine images and is a predetermined height, wherein, if the virtual storage unit has therein the book spine images and the first height of at least one of the book spine images exceeds the predetermined height, the third height will increase automatically to equal or exceed the maximum first height.

6. The method of claim 1, further comprising the step of displaying, as soon as the user moves a position pointer to one of the book spine images on the book data interface effectively, at least one of the bibliographic data and the book cover image associated with the book spine image in an appropriate area.

7. The method of claim 3, further comprising the step of displaying, as soon as the user moves a position pointer to one of the book spine images on the book data interface effectively, the book cover image associated with the book spine image on a side next to the book spine image and adjusting the dimension of the book cover image proportionately and automatically such that the second height thereof equals the first height of the book spine image.

8. The method of claim 7, further comprising the step of determining whether a position pointer has been moved away from the book spine image effectively, not displaying the book cover image if the position pointer has been moved away from the book spine image effectively, and displaying the book cover image continuously if the position pointer has not yet been moved away from the book spine image effectively or the position pointer has been moved to the book cover image.

9. The method of claim 8, further comprising the step of displaying the bibliographic data associated with the book spine image when the position pointer has been moved to the book cover image effectively and has stayed therein for at least a predetermined duration or has been selected.

10. The method of claim 1, further comprising the step wherein, if the user moves a position pointer to one of the book spine images on the book data interface effectively and selects it, the selected book spine image will move together with the position pointer.

11. A method for browsing book data on a computer terminal, the method comprising the steps of:
providing a book data application program installed and executed on the computer terminal to display a book data interface on a display, the book data interface comprising an archival zone having at least a virtual bookshelf space;
providing a book database, the book database comprising a plurality of book data, each book data being attributed to a physical or electronic book, the each book data at least comprising a book cover image, a book spine image, and a bibliographic data associated with the book; and
fetching at least a book data from the book database in response to a query sent from a user by the computer terminal, sending the book data to the computer terminal, and displaying book spine images of the book data in the virtual bookshelf space side by side so as to display more said book data in the archival zone.

12. The method of claim 11, wherein the book spine images attributed to the book data are arranged in the virtual bookshelf space side by side in either upright or prone manner.

13. The method of claim 11, wherein the book spine images are substantially rectangular and have a first width and a first height, and the book cover images are substantially rectangular and have a second width and a second height, wherein the virtual bookshelf space comprises at least a virtual storage unit with a third width and a third height.

14. The method of claim 13, wherein the third width of the at least a virtual storage unit is not less than the first width of the book spine image, the third width being a predetermined fixed width, wherein, if a total of the first widths of all the book spine images arranged in one of the at least a virtual storage unit in a predetermined sequence exceeds the third width of the virtual storage unit, the final book spine image will be moved automatically to another adjacent said virtual storage unit and arranged therein, such that the total of the first widths of all the book spine images in the virtual storage unit does not exceed the third width of the virtual storage unit.

15. The method of claim 13, wherein the third height of the at least a virtual storage unit is not less than the first height of the book spine images and is a predetermined height, wherein, if the virtual storage unit has therein the book spine images and the first height of at least one of the book spine images exceeds the predetermined height, the third height will increase automatically to equal or exceed the maximum first height.

16. The method of claim 11, further comprising the step of displaying, as soon as the user moves a position pointer to one of the book spine images on the book data interface effectively, at least one of the bibliographic data and the book cover image associated with the book spine image in an appropriate area.

17. The method of claim 13, further comprising the step of displaying, as soon as the user moves a position pointer to one of the book spine images on the book data interface effectively, the book cover image associated with the book spine image on a side next to the book spine image and adjusting the dimension of the book cover image proportionately and automatically such that the second height thereof equals the first height of the book spine image.

18. The method of claim 17, further comprising the step of determining whether a position pointer has been moved away from the book spine image effectively, not displaying the book cover image if the position pointer has been moved away from the book spine image effectively, and displaying the book cover image continuously if the position pointer has not yet been moved away from the book spine image effectively or the position pointer has been moved to the book cover image.

19. The method of claim 18, further comprising the step of displaying the bibliographic data associated with the book spine image when the position pointer has been moved to the book cover image effectively and has stayed therein for at least a predetermined duration or has been selected.

20. The method of claim 11, further comprising the step wherein, if the user moves a position pointer to one of the book spine images on the book data interface effectively and selects it, the selected book spine image will move together with the position pointer.

21. A system for browsing book data on a computer terminal, the system comprising:
a processor;
a storage device;
a book data interface provided and displayed on a display on the computer terminal in response to a query sent from a user by the computer terminal, the book data interface comprising an archival zone having at least a virtual bookshelf space; and
a book database stored in the storage device and accessible by the computer terminal, the book database comprising a plurality of book data, each said book data being attributed to a physical or electronic book, each said book data at least comprising a book cover image, a book spine image, and a bibliographic data associated with the book;
wherein, after fetching the book data, the computer terminal displays the book spine images of the book data in the virtual bookshelf space side by side so as to display more said book data in the archival zone.

22. The system of claim 21, wherein the book data interface is a webpage.

23. The system of claim 21, wherein the book data interface is displayed by means of a book data application program installed and executed on the computer terminal.
